(19) United States
(12) Patent Application Publication
(10) Pub. No.: US 2026/0288110 A1
(43) Pub. Date: Sep. 24, 2026

(54) SYSTEM FOR ACHIEVING FLEXIBLE MANAGEMENT OF THE PRODUCTION PROCESS AND DIGITAL TWIN INTEROPERABILITY

(71) Applicant: Mitsubishi Electric Corporation, Tokyo (JP)

(72) Inventor: Kazuma MAKITA, Vernon Hills, IL (US)

(73) Assignee: Mitsubishi Electric Corporation, Tokyo (JP)

(21) Appl. No.: 19/086,241

(22) Filed: Mar. 21, 2025

(51) Int. Cl. G05B 19/4069

(52) U.S. Cl. CPC G05B 19/4069; G05B 2219/32301

(57) ABSTRACT

A system for creating a virtual production line, the system including a Digital Twin for synchronizing data with a manufacturing facility, a Virtual Digital Twin including a user interface, the Virtual Digital Twin being for receiving the synchronized data from the Digital Twin, receiving a user input, via the user interface, of one or more products to be produced, creating virtual production line data including a virtual production line for each of the one or more products to be produced, generating a new production schedule for the one or more products, and generating a simulation of the new production schedule in a virtual version of the manufacturing facility, and a manufacturing execution system (MES) for controlling and operating the manufacturing facility.

### SUMMARY

The present disclosure may be regarded as being directed to systems and methods that can implement a Virtual Digital Twin system to enable flexible production process management and optimization in manufacturing facilities.

According to an aspect, a Virtual Digital Twin system includes a Digital Twin that is configured to synchronize data with a manufacturing facility, a Virtual Digital Twin including a user interface, the Virtual Digital Twin being configured to receive the synchronized data from the Digital Twin, receive a user input, via the user interface, one or more products to be produced, create virtual production line data including a virtual production line for each of the one or more products to be produced, generate a new production schedule for each of the one or more products, and send the new production schedule to the Digital Twin, and a manufacturing execution system (MES) configured to operate the manufacturing facility and to receive the virtual production line data from the Virtual Digital Twin, wherein the Digital Twin is further configured to generate a simulation of the new production schedule in a virtual version of the manufacturing facility.

According to another aspect, a Virtual Digital Twin, which includes a user interface, is configured to receive data from a Digital Twin that is synchronized with a manufacturing facility, receive a user input, via the user interface, one or more products to be produced, create a virtual production line for each of the one or more products to be produced, generate and display on the user interface a new production schedule for the one or more products, cause the Digital Twin to generate and display on the user interface a simulation of the new production schedule in a virtual version of the manufacturing facility, and send the new production schedule to a manufacturing execution system (MES) that is configured to operate the manufacturing facility.

Yet another aspect includes a method for a Virtual Digital Twin system includes synchronizing, by a Digital Twin, data with a manufacturing facility, receiving, by a Virtual Digital Twin, the synchronized data from the Digital Twin, receiving a user input, via a user interface, one or more products to be produced, creating, by the Virtual Digital Twin, virtual production line data including a virtual production line for each of the one or more products to be produced, generating, by the Virtual Digital Twin, a new production schedule for each of the one or more products, generating, by the Digital Twin, a simulation of the new production schedule in a virtual version of the manufacturing facility, and receiving, by a manufacturing execution system (MES), the virtual production line data from the Virtual Digital Twin.

### BRIEF DESCRIPTION OF THE DRAWINGS

FIG. 1 is a diagram illustrating an overall Virtual Digital Twin system configuration according to one or more embodiments of the present disclosure.

FIG. 2 illustrates a process of generating the Virtual Digital Twin according to one or more embodiments of the present disclosure.

FIG. 3 illustrates an example of a Digital Twin asset model according to one or more embodiments of the present disclosure.

FIG. 4 illustrates an example of a Virtual Digital Twin asset model according to one or more embodiments of the present disclosure.

FIG. 5 illustrates an example of a generated Virtual Digital Twin interface according to one or more embodiments of the present disclosure.

FIG. 6 is a flowchart of a validation process of the Virtual Digital Twin performed through simulation according to one or more embodiments of the present disclosure.

FIG. 7 illustrates a Virtual Digital Twin interface screen created for production optimization according to one or more embodiments of the present application.

### DETAILED DESCRIPTION

Aspects will now be described with reference to the accompanying drawings, wherein the same reference numerals have been used to identify the same or similar elements throughout the several views. Further, scope will become apparent from the detailed description given hereinafter. However, the detailed description and specific examples, while indicating embodiments of the present disclosure, are given by illustration only, since various changes and modifications within the spirit and scope of the present disclosure.

With the increasing need for high-mix, low-volume production in the manufacturing industry, production management systems leveraging Digital Twin technology have gained attention. Conventional Digital Twin technology mainly focuses on digitally replicating physical equipment conditions, making it effective for equipment monitoring and anomaly detection. However, it has not been sufficient for optimizing entire production lines or managing individual workpieces.

While conventional approaches allow detailed monitoring from an equipment perspective, they struggle with tracking progress and work-in-progress (WIP) from a workpiece perspective, making production planning and resource allocation optimization difficult. To address these issues, the present disclosure introduces a system that constructs a virtual production line, enabling visualization and optimization of production conditions on a per-workpiece basis. This extends (e.g., utilizes) Digital Twin technology (designated as a Virtual Digital Twin), allowing for more precise production management.

Previously methods including displaying Digital Twin environments for different domains or roles side by side. Specifically, in conventional technology, when an object displayed in one Digital Twin is affected, the corresponding object in other Digital Twins is also shown as affected. However, in this conventional approach, it is difficult to track individual product production status accurately in high-mix, low-volume manufacturing, limiting effective production planning optimization.

The present disclosure overcomes these limitations, aiming to provide a next-generation production management system that supports high-mix, low-volume production. According to one or more embodiments, a Virtual Digital Twin system is used in manufacturing facility (e.g., factory) and the like, allows for simulation of one or more operations of the manufacturing facility to enable flexible parallel production of multiple products, including different products which require different processes to produce. In contrast, the present disclosure involves on production process optimization, offering detailed production tracking and WIP management on a per-workpiece basis. By utilizing virtual production lines, the system according to the present disclosure enables production planning without being constrained by factory layouts or equipment limitations. Additionally, the Virtual Digital Twin system can simulate different versions of the same product to determine which version can efficiently be produced in the manufacturing facility (i.e., which version has the highest yield rate, production rate, etc.) or which version meets predetermined criteria.

Furthermore, the present disclosure differs from conventional technologies by incorporating Digital Twin technology to design an optimized production flow in a virtual environment and feeding it back into actual factory operations. Specifically, can generates independent virtual production lines per product model or per different versions of the same product model, allowing more precise control. Different versions of the same product model include the use of different materials, having different technical constraints, and the like, but are not limited thereto.

Digital Twin technology can refer to a virtual replica (e.g., digital model) of a physical object, person, system, or process, contextualized in a digital version of its environment that can perform real-time synchronization between physical and digital components. For instance, Digital Twin technology can support real-time monitoring of equipment and machinery, enabling the early detection of issues and reducing response times, to improve stability and reliability of manufacturing and optimizing operations (e.g., factory operations) by integrating data collected from various machines/equipment and/or facilities and performing real-time analysis of this data.

Digital twin technology can be a virtual representation that spans the object's lifecycle, is updated from real-time data (including manufacture data, device specific data, user data, past troubleshooting data, and the like) and uses simulation, machine learning, and reasoning to help make decisions. Real-time data can include data from sensors and other devices, system specifications, project files (e.g., imported data, parameters, project settings, etc.), operational data, maintenance data, troubleshooting data, Ladder theorem, video data and the like. Ladder theorem can refer to programming rules that are applied, which can utilize a graph design to represent a program. The graph design can be based on circuity diagrams of relay logic hardware and can be utilized to develop software for programmable logical controllers (PLCs) used in industrial control applications, such as in factories. Digital Twin may also be referred to as a “digital shadow” or a “digital model.” Digital twin technology enhances connectivity and communication between various systems, optimizing production processes and enabling real-time monitoring and decision-making, and may be internet-based.

### Overall System Configuration

The system according to one or more embodiment of the present disclosure includes the following components: high-mix, low-volume production facility (e.g., or a plurality of high-mix, low-volume production facilities), at least one Digital Twin, a manufacturing execution system at least one Virtual Digital Twin and a Virtual Product Line generator. High-mix, low-volume production factories refers to manufacturing environment that produces a wide variety of products in small quantities, which is a type of production that is often used for custom or specialized products where the demand for each individual product is low. For example, in the high-mix, low-volume production facilities (e.g., factories) can include machines and autonomous mobile robots (AMRs) that can operate in coordination, enabling flexible parallel production of multiple product types.

A Digital Twin refers to a system that reproduces the operational status of real factories and equipment in a virtual environment using real-time data, enabling constant monitoring, predictive analytics, and simulations. However, the present disclosure is not limited to high-mix, low-volume production facilities, and may be applicable to any type of facility. For instance, the present disclosure can also be used on low-volume, low-mix facilities and mass customization involving producing high volumes of products, where the products can be individually customized. The Digital Twin can be implemented by a using circuitry or processing circuitry which includes general purpose processors, special purpose processors, integrated circuits, ASICs (“Application Specific Integrated Circuits”), FPGAS (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

A manufacturing execution system (MES) refers to a system that comprehensively manages and optimizes on-site manufacturing activities, such as production schedules, resource management, and the distribution of work instructions within a factory. This enables improved production efficiency and real-time information sharing. MES can refer to is a software system that acts as the bridge between enterprise resource planning (ERP) and facility floor controls. It provides real-time visibility into production, tracking everything from orders and resources to quality and maintenance. An MES streamlines operations and provides data-driven insights and can incorporate technologies like AI, IoT, and cloud computing, as known in the art. The MES may have a main role of operating the production process of one or more product in the production facility, including executing at least one schedule. MES platforms can additionally integrate inventory tracking, adjusting stock levels as raw materials turn into finished goods. The MES can be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

A Virtual Digital Twin according to one or more embodiment of the present disclosure is a system that utilizes data (e.g., receives factory data) from the Digital Twin to visualize and manage production progress and WIP status per product model. This allows for optimized production process control, which was previously challenging. The Virtual Digital Twin can be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The Virtual Digital Twin according to one or more embodiment of the present disclosure can directly match up to the manufacturing facility, but can have variations from the factory to alter how the manufacturing facility operates and what products are produced, including products of different types and/or configurations. These alterations include how the production machines are arranged, the types of machine and the number of machines (e.g., additional machines can be added to the production line in the Virtual Digital Twin). For instance, the production factory can have one computer numeral control (CNC machine), and the Virtual Digital Twin can have two or more CNC machines to allow for improvements to the production process, or to perform additional processes to the product.

### System Operations

Systems and methods according to one or more embodiment of the present disclosure can collect real-time data from actual equipment to visualize and manage WIP status and production progress per product model in a virtual environment. Additionally, systems and methods according to one or more embodiment of the present disclosure can conduct optimization simulations in the virtual environment of the Virtual Digital Twin and feed the results back to the actual (e.g., real life) manufacturing facility system (e.g., via the MES), enabling automatic production schedule adjustments and optimal resource allocation.

According to one or more embodiments of the present disclosure, in High-Mix, Low-Volume Production, real-time visualization of production progress and WIP at the product model level enhances the accuracy of production management. This is particularly useful in precision parts factories where CNC machines are used for workpiece processing and AMRs are used for workpiece transportation, requiring on-site operators to track the progress of each workpiece in real time.

Production Progress data, including timestamps for machining start and completion as well as work status, is collected from CNC machines, AMRs, and automated warehouses and synchronized with the Digital Twin environment. An automated warehouse is a facility where core warehouse operations, like receiving, storage, order picking, and shipping, are carried out with minimal human intervention.

Production Progress data from the Digital Twin and Production Planning data (e.g., including at least production targets, production quantity, and yield rates) from the MES are aggregated in the Virtual Digital Twin environment. The aggregated data is used to generate independent Virtual Production Lines for each product model, visualizing WIP status.

With the system and method according to one or more embodiments of the present disclosure, operators can instantly check the current progress of each workpiece and identify where WIP is accumulating at each process step. This allows for the rapid identification of bottlenecks and real-time responses. As a result, it helps reduce lead time, optimize inventory management, improve workflow between processes, and enhance overall productivity in the manufacturing site.

### Optimization of Production Scheduling for Medical Device Parts

By constructing Virtual Production Lines within the Virtual Digital Twin and simulating the optimal production planning for each workpiece, the system according to one or more embodiments of the present disclosure enables real-time reflection of the simulation results in the actual factory system and allows for automatic production planning adjustments. For example, in medical device parts factories that utilize CNC machines and grinding machines, along with AMRs for workpiece transportation, real-time adjustments are required to address sudden machining delays or resource allocation imbalances.

This approach enables rapid simulation of changes in production planning within the Virtual Digital Twin, allowing for the derivation of optimal schedules. Consequently, it minimizes production delays caused by unexpected equipment failures or resource allocation imbalances, reduces lead time, and improves manufacturing efficiency.

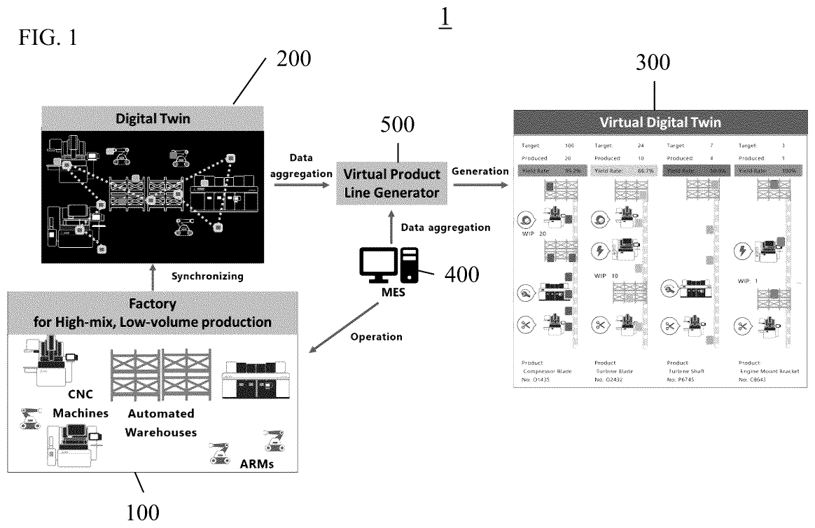

FIG. 1 illustrates a diagram of the overall Virtual Digital Twin system configuration according to one or more embodiments of the present application. The Virtual Digital Twin system 1 includes a factory (e.g., manufacturing facility) 100, a Digital Twin 200, a Virtual Digital Twin 300, a MES 400, and a Virtual Product Line Generator 500.

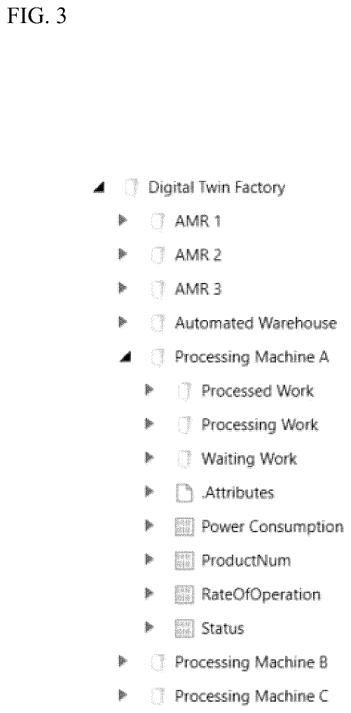

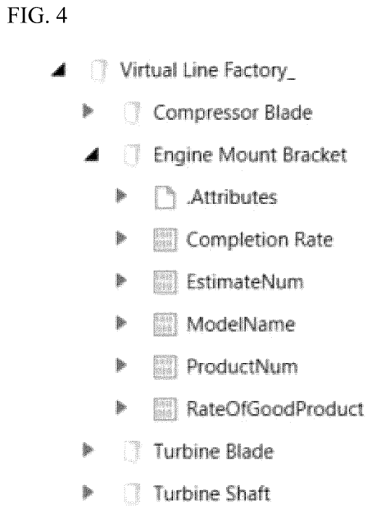

The Virtual Digital Twin provides expanded capabilities as compared to a system with only a Digital Twin. Data from the factory is synchronized with the Digital Twin. For instance, the MES can the primary source of real-time data for the Digital Twin. The MES can act a manager of the shop floor by executing production plans, collecting live data, and keeping machines and processes operating within production constraints, the Digital Twin serves as a virtual mirror and testing ground, using that data to reflect reality or explore scenarios. That is, the MES can feed the Digital Twin raw, real-world inputs it needs to stay accurate. Data of the factory is transferred from the Digital to the Virtual Digital Twin. A Virtual Product Line (VPL) generator can refer to a digital process performed by a computer and the like to convert the job shop style asset model of the Digital Twin to a virtual product line style, which is to be described in more detail with respect to FIGS. 3 and 4 below. The VPL generator can be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

In the job shop style (e.g., machine-centric hierarchy) refers to an asset model in which the components of the manufacturing facility are arranged as a machine based hierarchy, as shown in FIG. 3. The virtual product line style refers to an asset model in which products to be manufactured are arranged (e.g., product-centric hierarchy), as shown in FIG. 4. An asset model refers to a structured representation of reusable components, resources or other assets to create products and/or systems, and can be stored in memory of the Digital Twin and/or Virtual Digital Twin. The job shop style can be stored in memory of the Virtual Digital Twin system 1 and/or in memory of the Digital Twin 200 and the virtual product line style can be stored in memory of the Virtual Digital Twin system 1 and/or in memory of the Virtual Digital Twin 300. In a manufacturing facility, a product-based asset model focuses on organizing all relevant data around the products being made, rather than, say, the machines or departments alone. Files are arranged by product (e.g., “Engine mount bracket,” “turbine blade,” “turbine shaft,” and the like) and the memory contains everything a Digital Twin needs to mirror and analyze the manufacturing process for that product.

In other words, the Digital Twin can store data arranged according to the hierarchy of physical position(s) corresponding to machine(s), warehouse(s) (e.g., component storage facility) and/or other devices in the manufacturing facility, in correspondence with the job shop style asset model. The Digital Twin traces machine status and the current process(es) of the various machines.

The Digital Twin can be a digital representation of the factory and can have strict and direct correspondence to each of the machine(s)/devices of the factory. All operational data from the factory can be synchronized to the Digital Twin, which is then fed from the Digital Twin to the Virtual Digital Twin (e.g., directly or via the VPL generator). The Virtual Digital Twin can use this retrieved data to allow a user, via a user interface, to input product information, including production constraints, and the Virtual Digital Twin can automatically determine a process for the manufacturing facility to produce the desired product. Additionally, Virtual Digital Twin allows for digital alteration of how the factory operates, including adding more or fewer machines to produce different products.

The user interface can be provided, which can display one or more prompts to receive a user query. An input device, such as a keyboard, mouse, touch-screen display, microphone, and the like, can be provided for the user to provide the query to the Virtual Digital Twin system. Examples of such input devices include computers (e.g., personal), mobile/cellular phones/devices, handheld messaging devices, laptop computers, tablet computers, set-top boxes, personal data assistants, embedded computer systems, electronic book readers, and the like.

Data between the factory, the Digital Twin and the Virtual Digital Twin can be transferred directly through an electrical contact, or through wireless communication, such as a network. According to one or more embodiments of the present disclosure, the network can include any appropriate network, including an intranet, the Internet, a cellular network, a local area network, a satellite network or any other such network and/or combination thereof, and components used for such a system may depend at least in part upon the type of network and/or system selected. According to one or more embodiments of the present disclosure, communication over the network can be enabled by wired and/or wireless connections and combinations thereof. According to one or more embodiments of the present disclosure, the network can include the Internet and/or other publicly addressable communications network, as the system includes a web server for receiving requests and serving content in response thereto, although for other networks an alternative device serving a similar purpose could be used.

The user interface can be in the form of a Virtual Digital Twin interface, which allows for user input of specifications for a product to be produced, including a product model, production targets, production count, yield rate, WIP quantity and product name. Virtual Digital Twin interface allows user to enter a new product (e.g., with target and model #), and the Virtual Digital Twin will determine how to produce the product and determine the yield rate. In the factory of FIG. 1, the autonomous robotic arm (ARM) can replace or be replaced by conveyor belt(s) to move the product during manufacture and assembly.

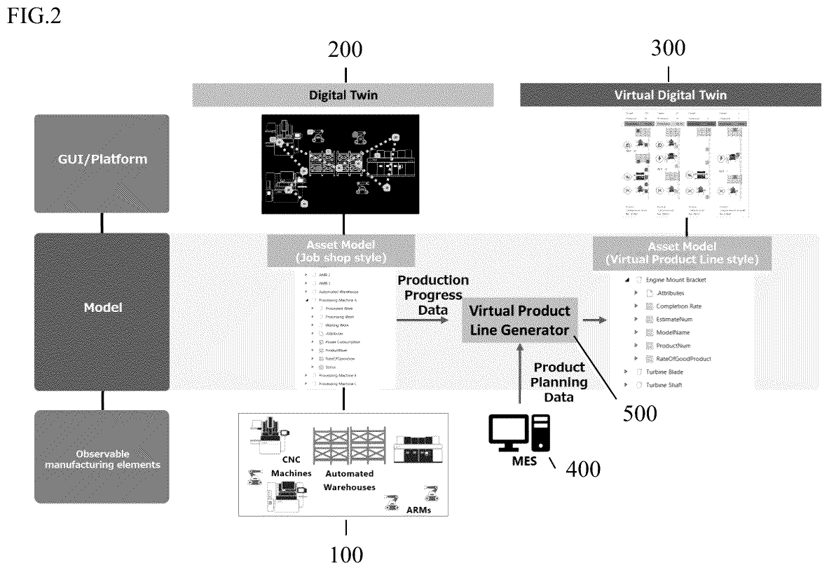

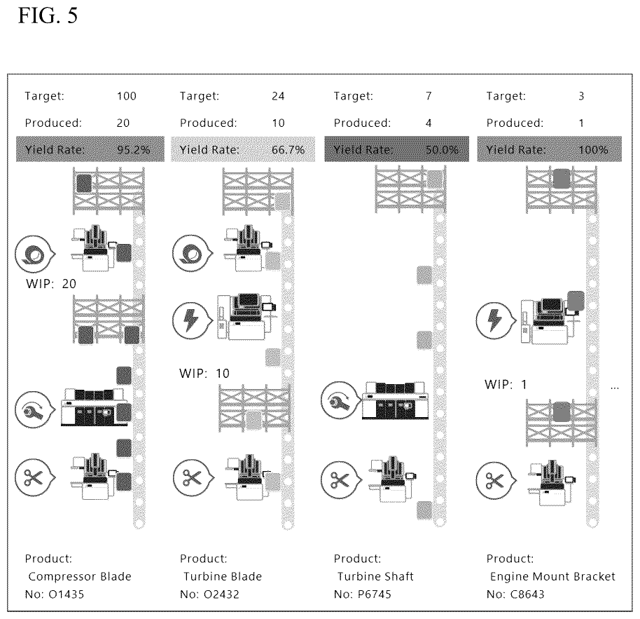

FIG. 2 illustrates a process of generating the Virtual Digital Twin according to one or more embodiments of the present disclosure. The structure of a Digital Twin can be broadly categorized into two components: the GUI/Platform, which provides a visual representation, and the model, which hierarchically manages data based on physical configurations (e.g., machine-based). This structure is referred to as the asset model. By restructuring the asset model data along with production management data from the MES (Manufacturing Execution System) for each product model, a Virtual Digital Twin is formed, generating data for a Virtual Production Line. That is, FIG. 2 illustrates how the Asset Model of the Digital Twin is transformed to create independent Virtual Production Lines for each product model. A user, via a user interface, can add a product line to the manufacturing facility, such as any of the lines shown in FIG. 5.

As shown in FIG. 2, both the Digital Twin and the Virtual Digital twin can be operated in a same or separate graphical user interfaces (GUIs). The GUI of the Digital Twin can be tailored to reflect managing machines, and the GUI of the Virtual Digital Twin can be tailored to reflect managing and tracking products (e.g., including new products that have not yet been produced). The GUI for the Digital Twin and Virtual Digital twin include the virtual factory and allow for modification of simulation conditions and to make decisions without needing to dig into raw code or databases.

FIG. 3 illustrates an example of a Digital Twin asset model (i.e., machine-centric model) according to one or more embodiments of the present disclosure, as previously discussed. This diagram presents an machine-centric asset model that structures data hierarchically according to physical configurations of the manufacturing facility. The model is built based on physical equipment within the factory, such as machining tools, Autonomous Mobile Robots (AMRs), and automated warehouses.

A machine-centric model (e.g., job shop style) for storing information in a manufacturing facility to support a Digital Twin takes a different angle from a product-based approach. Instead of organizing data around the products being made, this model puts the machines, the equipment doing the work, at the center of the structure. Files are organized a piece of equipment (e.g., “CNC Lathe,” “Press Machine,” etc.), and includes all aspects related to that machine's role in the facility. Key components of the machine-centric model is each machine is the focal point. Its “profile” includes all the details tied to it. its type (e.g., CNC machine, ARM, etc.), specifications (e.g., power, speed), current status (e.g., running, down), and its location in the facility. The model then branches out to what that machine does, rather than what's being made. The machines themselves are the primary asset, and its metadata includes at least serial number, maintenance logs (e.g., last serviced Jan. 23, 2025), operating parameters (e.g., max RPM), and sensor data (e.g., vibration levels), but is not limited thereto. Other assets, such as tools or operators, are linked to the machine based on their usage with it. Processes are defined by what the machine performs, not the end product.

For instance, a cutting machine's process might be “cut steel at 15 cm/sec,” regardless of whether it's making component A or component B. The machine-centric model logs inputs (e.g., raw material fed in) and outputs (e.g., parts produced) per machine, giving a clear view of its role in the workflow. Sensors on each machine feed live data into the machine-centric model of the Digital Twin, either directly by the factory or through the MES. Live data includes as temperature, pressure, or energy consumption, etc., but is not limited thereto. Data is stored under the machine's memory, so the Digital Twin can monitor its health and performance in real time. For example, “Press Machine” might show a spike in power draw, signaling a potential issue. Additionally, the machine-centric model can include historical and predictive layers by tracking each machine's past activity (e.g., total hours run, downtime events) and pairing this historical data with predictive insights (e.g., likelihood of failure based on wear). Data can be stored in a database or the Digital Twin platform, with each machine as a top-level entity. Sub-records tie in related data—processes, materials, and metrics—all linked back to that machine. FIG. 3 illustrates memory records of the Digital Twin, including AMR 1, AMR 2, AMR 3, automated warehouse, Processing Machine A, Processing Machine B and Processing Machine C. Each machine folder (i.e., main folder) has additional sub folders. FIG. 3 shows Processing Machine A with subfolders of processed work, processing work, waiting work, attributes (of Processing Machine A), power consumption, product number (ProducNum), rate of operation (RateOfOperation), Status. Each main folder can include similar subfolders to Processing Machine A, but is not limited thereto. The machine-centric model focuses on equipment performance, maintenance, and utilization rather than the final product. In a facility with expensive or complex machinery, understanding how each machine operates, its efficiency, bottlenecks, or failure risks, can be more critical than tracking the product flow.

FIG. 4 illustrates an example of a Virtual Digital Twin Asset Model (product-centric model). FIG. 4 illustrates a product-centric asset model that has been restructured and re-layered, for instance, by the VPL generator, based on product model classifications. In product line style asset model (e.g., product-centric model) the product is the backbone of the model itself. Each product has its own “profile” that ties together all associated assets—like machinery, tools, materials, and even workers—used in its production. For example, if you're making a vehicle part, the model stores data on the stamping machine, the steel coils, and the assembly line steps specific to that part. Every asset linked to a product can receive detailed tags.

In the Virtual Line Factor of FIG. 4, folders include compressor blade, engine mount bracket, turbine blade and turbine shaft, but it is not limited thereto. The engine mount bracket folder includes subfolders for attributes, completion rate, estimate number of products (EstimateNum), model name (ModelName), product number (ProductNum) and rate of good product (RateOfGoodProduct), but is not limited thereto. Each of the main folders can include similar subfolders to the engine mount bracket.

For instance, a machine might have info like its ID, current status (running, idle), maintenance history, and output capacity. Raw materials might include supplier details, batch numbers, and quality metrics. This metadata is structured so the Virtual Digital Twin can pull it (from the Digital Twin) instantly for simulations. The model captures the sequence of steps to make the product, which can be designated as a recipe. For each step, it links to the assets involved and logs data like cycle time, energy use, or defect rates. This lets the Virtual Digital Twin track how changes in one step affects the whole process. Sensors and IoT devices in the manufacturing facility feed live data into the model via the Digital Twin—temperature, vibration, production speed, etc. The model organizes this by product, so the Virtual Digital Twin can see what's happening with component A production right now, not just the facility as a whole. Beyond current data, each model can store past performance (e.g., how many units of “component B” were made during a selection period of time) and integrates predictive analytics (e.g., when a machine might fail). This helps the Virtual Digital Twin forecast issues or optimize schedules.

Focusing on products in the Virtual Digital Twin aligns the model with the facility's core output (e.g., what you're actually making). It's especially handy for a Virtual Digital Twin because it mirrors the real-world goal of producing goods efficiently. Unlike a machine-centric model, where data is siloed by equipment, this approach connects everything to the product's lifecycle, making it easier to simulate scenarios, such as tweaking the design of component A or scaling up production of component B.

As shown in FIG. 2, the VPL generator converts the job or machine-based asset model of the Digital Twin to a product-based asset model of the Virtual Digital Twin. The VPL generator is optionally provided and can be used to convert a machine-centric model for the manufacturing facility's Digital Twin to a product-centric model of the Virtual Digital Twin involves reorganizing the data structure from focusing on the machines to centering it around the products being made. In other words, the machine-centric model shows what each machine is doing, whereas the product-centric model shows the processes to make various products. Converting, by the VPL generator, the machine-centric model to the product product-centric model includes identifying the products and their requirements, e.g., automatically determining all the products the manufacturing facility makes, determine what is needed to produce each product, such as materials (e.g., raw inputs go, such as fasteners), processes (e.g., listing of various process to produce the product, such as cutting, assembling), and which assets are to be used (e.g., which machines, tools, or people are used at each step).

Further, the VPL generator can then reorganize the data around the products by shifting the hierarchy so each product becomes the top-level entity (e.g., reassociate all data tied to machine/devices with the products they serve), and restructure the process mapping to product-specific workflows (e.g., tracing each product's production sequence through the facility and using existing machine process data to build this timeline, linking each step to the assets involved to create a “recipe” for each product that the digital twin can follow). Further, the VPL generator can reassign real-time data streams synchronized by the Digital Twin, consolidate historical data (e.g., machine runtime or downtime) and predictive data (e.g., time to failure) and update the storage framework from machine-centric scheme (machine→metadata, processes, data) to the product-centric scheme (product→metadata (materials, steps), assets (machines, tools) and data (live/historical)).

A Manufacturing Execution System (MES) can act as the central nervous system for a factory floor, providing real-time visibility and control over production processes. It bridges the gap between high-level enterprise resource planning (ERP) systems and the shop floor's control systems, offering a granular view of operations. MES software collects data from machines, sensors, and operators, enabling manufacturers to track work-in-progress, monitor equipment performance, and enforce quality standards. This data is then used to optimize scheduling, manage materials, and ensure product traceability.

The MES permits can provide operators/users up-to-the-minute picture of their operations. Additionally, the MES can facilitate the efficient execution of production plans, minimizes downtime, and reduces waste by capturing and analyzing data related to every stage of the manufacturing process to improve product quality, increase efficiency, and enhance overall operational effectiveness.

FIG. 5 illustrates an example of a generated Virtual Digital Twin interface according to one or more embodiments of the present disclosure. The Virtual Digital Twin interface can be a user interface screen that is displayed on a display screen, such as a liquid crystal display (LCD), an light-emitting diode (LED) display, and organic LED (OLED) display, a touchscreen display (e.g., resistive and/or capacitive), and the like.

The user interface screen of FIG. 5 displays virtual production lines, in separate columns, corresponding to currently manufactured product models and/or an new products to be manufactured. That is, an operator can add new product models to determine whether they can be produced at the manufacturing facility and to determine the yield rate, production efficiency and all other data/attributes related to manufacturing the product. Additionally, the user interface can be used to compare with existing model(s) and/or other new product models. Each line can include at least production targets, yield rates (percentage of goods defect-free), work-in-process (WIP) quantity, product name, and product model, and the like.

By adding a new product model to the user interface of the Virtual Digital Twin, the Virtual Digital Twin will automatically generate the process to produce the product using the existing manufacturing facility. In addition, the Digital Virtual Twin can determine additional machines (e.g., devices) to be added to the manufacturing facility to enhance productivity of the new product model(s).

A significant benefit of the present disclosure is the ability of the user interface of the Virtual Digital Twin to display a yield rate for various product model(s), as shown in FIG. 5. A user can enter a desired (i.e., threshold) yield rate, a desired production rate, and the Virtual Digital Twin can highlight yield rates below the predetermined threshold yield rate to visually distinguish display product model(s) that do not meet the predetermined threshold. That is, the Virtual Digital Twin can allow users to enter a new product model (e.g., with a target yield and a model number, among other manufacturing characteristics), and the Virtual Digital Twin will automatically determine how to produce the product and determine the yield rate, based on the data retrieve from the Digital Twin. Additionally, the Virtual Digital Twin can be modified to add machines not currently present in the manufacturing facility to improve the yield rate for new product model entered by the user.

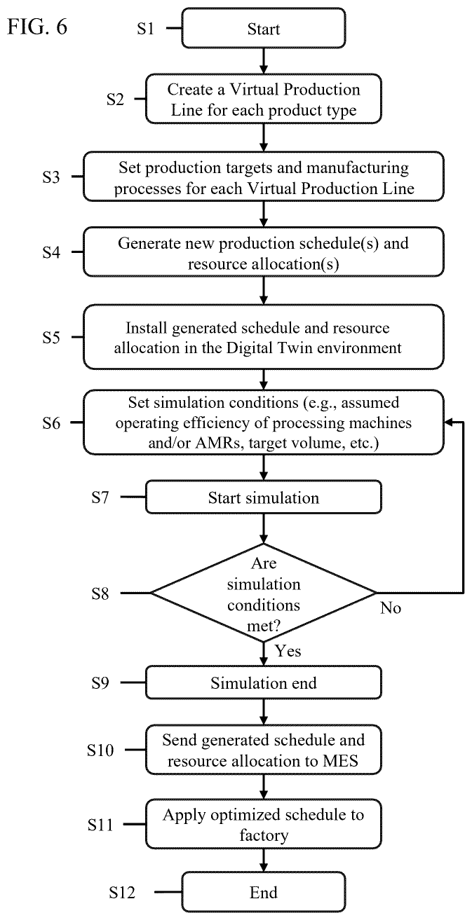

FIG. 6 is a flowchart of a validation process of the Virtual Digital Twin performed through simulation in the Digital Twin according to one or more embodiments of the present disclosure. That is, FIG. 6 illustrates validation of the information generated using the Virtual Digital Twin, including the flow of the validation that is carried out by simulating, in the Digital Twin, the production schedule and resource allocation information generated by operating the Virtual Digital Twin.

In step S1, the process starts. In step S2 a virtual production line is created by the Virtual Digital Twin for each product type/model selected by a user through the user interface. The product type/model can be selected through the converted asset model (product-centric model), including via a drop-down menu of the Virtual Digital Twin user interface, or can manually be entered by a user. In step S3, the production target(s) and manufacturing processes are set and/or selected for each virtual production line (i.e., new production line). Step S3 may be performed by the Virtual Digital Twin or by a user input.

In step S4, a new production schedule and resource allocation are generated by the Virtual Digital Twin. In step S5, the generated new production schedule and resource allocation can be sent to and installed in the Digital Twin. That is, in step S5, the generated new production schedule and resource allocation can be displayed in a user interface screen. In step S6, the Virtual Digital Twin sets simulation conditions in the manufacturing facility to produce the inputted product(s), including specific parameters, scenarios, and environmental factors set up within Virtual Digital Twin to mirror, analyze, or predict the behavior of a manufacturing facility (or its assets) under various circumstances. For example, the simulation conditions can include operating efficiency, lifecycle and production, such as the duration of a cutting process, and the like. Alternatively, a user can set the simulation conditions.

In step S7, the Digital Twin receives the set simulation conditions and starts the simulation of the virtual production lines and in step S8, the Digital Twin determines if the simulation conditions are met. Alternatively, the Virtual Digital Twin can receive the simulation results from the Digital Twin and can determine if the simulation conditions are met. If the simulation conditions are not met, step S6 is repeated, and different simulation conditions are set by the Virtual Digital Twin. That is, the Digital Twin can confirm whether the simulation will be feasible in the manufacturing facility. These different simulation conditions can be automatically set by the Digital Twin or the Virtual Digital Twin or can be set by a user, through the user interface.

After determining that simulation conditions are met, the simulation ends in step S9. In step S10, the generated schedule and resource allocation is sent from the Virtual Digital Twin and/or the Digital Twin to the MES. In step S11, the MES controls the manufacturing facility based on the generated schedule or an optimized schedule that has been optimized by the Virtual Digital Twin. That is, in step S10, the Digital Twin can send data of the virtual production line(s) to the MES to allow for direct manufacture of the new production line(s). Finally, in step S12, the process ends. Any of the steps S2-S11 can be repeated.

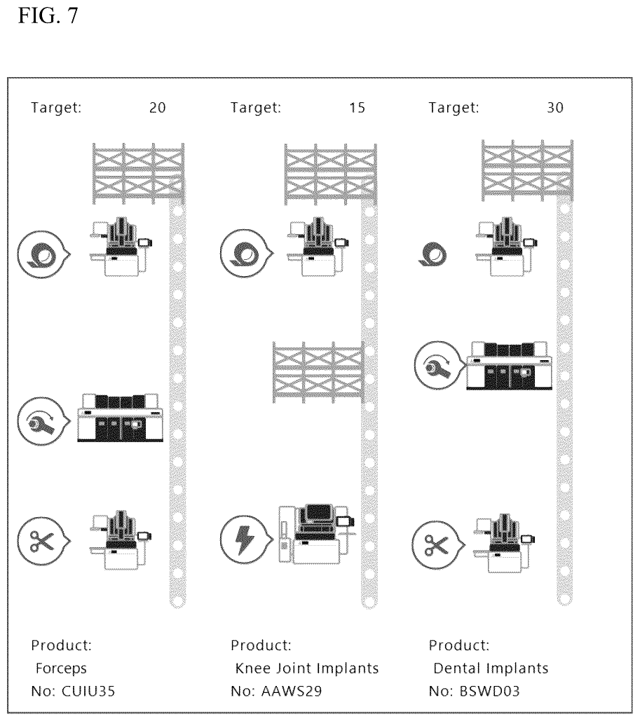

FIG. 7 illustrates a Virtual Digital Twin interface screen created for production optimization according to one or more embodiments of the present application. For each product model a user desires to produce, a virtual production line is created on the Virtual Digital Twin, and the user can set the production targets and production processes (e.g., CNC processing, grinding, cleaning, inspection, etc.) for each. A user can add virtual production line(s) to the graph for new products, that is, the user can add the production process here or the Virtual Digital Twin can automatically determine the production process. Information such as the production target, model number, name, etc. can be added to the virtual production like by the user. FIG. 7 illustrates results of different simulations performed on the Digital Twin, with each simulation representing a different product. For instance, the left-most portion of FIG. 7 illustrates a virtual production/manufacturing line for producing forceps, the central-portion FIG. 7 illustrates a virtual production/manufacturing line for producing knee joint implants, and the right-most portion of FIG. 7 illustrates a virtual production/manufacturing line for producing dental implants. Each of the virtual production/manufacturing lines of FIG. 7 also include corresponding machines of the manufacturing facility that will be used in the manufacturing process, as well as a target number of products to be produced and a product number.

(1) A system that constructs a virtual production line different from the physical equipment configuration in manufacturing sites, integrates it with Digital Twin technology, and visualizes and optimizes production conditions. In high-mix, low-volume production factories, this system facilitates tracking production status per workpiece, which was previously challenging. Additionally, it enables visualization and optimization of Work-in-Progress (WIP) and production progress, improving production management accuracy.

(2): The system of (1), wherein it acquires operational data from actual equipment and provides real-time visualization of production progress and inventory status in a virtual environment. The effect of (2) is enhancing the accuracy of production planning, supports decision-making by on-site operators, enables real-time adjustments, and reduces lead time.

(3): The system of (1), wherein the virtual production line includes production information such as WIP status, real-time operational data, production results per product model, production targets, and yield rate s. The effect of (3) is an increase in manufacturing process transparency, enabling real-time quality management and production plan optimization. (Improves yield rate??)

(4): The system of (1), wherein a virtual production line is constructed by converting equipment production data using Digital Twin technology. The effect of (4) is reducing system construction workload by leveraging existing Digital Twin technology.

(5): The system of (1), wherein production plans and optimized operational instructions generated in the virtual production line can be applied to actual factory equipment. The effect of (5) is enabling feedback from virtual environment simulation results to real factory operations, facilitating efficient production management.

(6): The system of (5), wherein production planning and resource allocation generated in the virtual environment are transmitted to actual equipment management systems, which then determine optimal control parameters based on the received data. The effect of (6) is enhancing resource utilization efficiency and improves production quality by applying virtual optimization results to real factory operations.

(7): The system of (5), wherein production optimization results in the virtual environment dynamically adjusting and automating the actual factory's operation schedule. The effect of (7) is enabling real-time production schedule adjustments, allowing flexible responses to fluctuating production demands and improving production planning adaptability.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

Various embodiments described herein may be implemented in a computer-readable medium using, for example, software, hardware, or some combination thereof. For example, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions may be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A Virtual Digital Twin system, the system comprising:
a Digital Twin that is configured to synchronize data with a manufacturing facility;
a Virtual Digital Twin including a user interface, the Virtual Digital Twin being configured to:
receive the synchronized data from the Digital Twin,
receive a user input, via the user interface, of one or more products to be produced,
create virtual production line data including a virtual production line for each of the one or more products to be produced,
generate a new production schedule for each of the one or more products, and
send the new production schedule to the Digital twin; and
a manufacturing execution system (MES) configured to operate the manufacturing facility and to receive the virtual production line data from the Virtual Digital Twin or the Digital Twin, wherein
the Digital Twin is further configured to generate a simulation of the new production schedule in a virtual version of the manufacturing facility.

2. The Virtual Digital Twin system according to claim 1, further including a virtual product line generator configured to convert a first asset model of the Digital Twin to a second asset model of the Virtual Digital Twin.

3. The Virtual Digital Twin system according to claim 2, wherein the first. asset model includes components of the manufacturing facility arranged in a machine based hierarchy, and
the second asset model bas products to be manufactured arranged in a product based hierarchy.

4. The Virtual Digital Twin system according to claim 1, wherein the Virtual Digital Twin is further configured to:
in response to receiving the user input of the one or more products to be produced, create the virtual production line for each of the one or more products, and
set production targets and manufacturing processes for each virtual production line.

5. The Virtual Digital Twin system according to claim 4, wherein the Virtual Digital Twin is further configured to:
display the generated schedule and resource allocation on the user interface, and
set simulation conditions, based on the user input.

6. The Virtual Digital Twin system according to claim 5, wherein the Virtual Digital Twin is further configured to send the generated schedule and the resource allocation to the MES, and
the MES is configured to control the manufacturing facility based on the received schedule and resource allocation to produce the one or more products.

7. The Virtual Digital Twin system according to claim 5, wherein the Digital Twin is further configured to:
determine whether the simulation conditions are met, and
in response to the simulation conditions not being met, set different simulation conditions, or cause the Virtual Digital Twin to set different simulation conditions.

8. The Virtual Digital Twin system according to claim 5, wherein the displayed user interface includes displaying the virtual production line for each of the one or more products, and
each virtual production line includes machines from the manufacturing facility to be used to manufacture the product, a target production rate, and simulated number of produced products, and a yield rate.

9. The Virtual Digital Twin system according to claim 1, wherein, for each of the one or more products, the Virtual Digital Twin is configured to set a production target and manufacturing processes to produce each product.

10. The Virtual Digital Twin system according to claim 1, wherein the Virtual Digital Twin is further configured to create the virtual production line for each product having a different equipment configuration than in the manufacturing facility, and
the generating the new production schedule for the one or more products includes optimizing production conditions for the different equipment configuration.

11. The Virtual Digital Twin system according to claim 1, wherein the Virtual Digital Twin is further configured to acquire operational data from actual equipment of the manufacturing facility from the Digital Twin and provide, in the virtual production line for each product, real-time visualization of production progress and inventory status.

12. The Virtual Digital Twin system according to claim 1, wherein each virtual production line includes production information, and
the production information includes work-in-progress status, real-time operational data, production results, production target, and yield rate.

13. The Virtual Digital Twin system according to claim 1, wherein the MES is further configured to use the virtual production line data to control and operate the manufacturing facility.

14. A Virtual Digital Twin, including a user interface, the Virtual Digital Twin being configured to:
receive data from a Digital Twin that is synchronized with a manufacturing facility,
receive a user input, via the user interface, of one or more products to be produced,
create a virtual production line for each of the one or more products to be produced,
generate and display on the user interface a new production schedule for the one or more products,
cause the Digital Twin to generate and display, on the user interface, a simulation of the new production schedule in a virtual version of the manufacturing facility, and
send the new production schedule to a manufacturing execution system (MES) that is configured to operate the manufacturing facility.

15. The Virtual Digital Twin according to claim 14, wherein the received data is converted from a first asset model, in which components of the manufacturing facility are arranged in a machine based hierarchy, to a second asset model, in which products to be manufactured are arranged in a product based hierarchy.

16. The Virtual Digital Twin according to claim 14, wherein the Virtual Digital Twin is further configured to:
set production targets and manufacturing processes for each virtual production line,
display the generated schedule and resource allocation in the user interface, and
set simulation conditions, based on user input.

17. The Virtual Digital Twin according to claim 16, wherein the Virtual Digital Twin is further configured to:
receive a determination, from the Digital Twin, whether the simulation conditions are met, and
in response to the simulation conditions not being met, set different simulation conditions or cause the Digital Twin to set different simulation conditions.

18. A method for controlling a Virtual Digital Twin system, the method comprising:
synchronizing, by a Digital Twin, data with a manufacturing facility;
receiving, by a Virtual Digital Twin, the synchronized data from the Digital Twin;
receiving a user input, via a user interface, of one or more products to be produced;
creating, by the Virtual Digital Twin, virtual production line data including a virtual production line for each of the one or more products to be produced;
generating, by the Virtual Digital Twin, a new production schedule for each of the one or more products;
generating, by the Digital Twin, a simulation of the new production schedule in a virtual version of the manufacturing facility; and
receiving, by a manufacturing execution system (MES), the virtual production line data from the Virtual Digital Twin.

19. The method according to claim 18, further comprising controlling, by the MES, the manufacturing facility based on the received virtual production line data and the new production schedule for the one or more products.

20. The method according to claim 18, further comprising, after generating the simulation of the new production schedule, determining, by the Digital Twin, whether predetermined simulation conditions are met;
in response to the simulation conditions not being met, setting different simulation conditions; and
in response to the simulation conditions being met, sending, by the Virtual Digital Twin, the virtual production line data to the MES.
